(19) United States
(12) Patent Application Publication
(10) Pub. No.: US 2014/0077584 A1
(43) Pub. Date: Mar. 20, 2014

(54) MOTOR HOUSING INTEGRATED-TYPE SPOKE FOR ELECTRIC BICYCLE, MANUFACTURING METHOD THEREOF, WHEEL ASSEMBLY HAVING THE SAME AND MANUFACTURING METHOD THEREOF

(71) Applicant: MANDO CORPORATION, Pyeongtaek-si (KR)

(72) Inventors: Jeong Rae KIM, Seoul (KR); Chang Bok KO, Namyangju-si (KR)

(73) Assignee: MANDO CORPORATION, Pyeongtaek-si (KR)

(21) Appl. No.: 13/683,501

(22) Filed: Nov. 21, 2012

(30) Foreign Application Priority Data
Sep. 19, 2012 (KR) 10-2012-104249

(51) Int. Cl. B60B 3/10; B29C 45/14

(52) U.S. Cl. CPC B60B 3/10; B29C 45/14
USPC 301/64.101; 264/271.1; 29/592.1

(57) ABSTRACT

A motor housing integrated type spoke for an electric bicycle and a manufacturing method thereof, a wheel assembly having the same, and a manufacturing method thereof, the motor housing integrated type spoke coupled to a rim and including a motor housing, which is provided at a center of the motor housing integrated-type spoke to accommodate a motor, the motor housing integrally formed with the motor housing integrated-type spoke through an injection molding.

### CROSS-REFERENCE TO RELATED APPLICATION

This application claims the benefit of Korean Patent Application No. 2012-0104249, filed on Sep. 19, 2012 in the Korean Intellectual Property Office, the disclosure of which is incorporated herein by reference.

### BACKGROUND

1. Field

Embodiments of the present disclosure relate to a motor housing integrated-type spoke for an electric bicycle, a manufacturing method thereof, a wheel assembly having the same, and a manufacturing method thereof, and more particularly, to a motor housing integrated-type spoke for an electric bicycle capable of enabling a motor to be easily installed at a motor driven bicycle and ensuring easy manufacturing and easy assembly process, a manufacturing method thereof, a wheel assembly having the same, and a manufacturing method thereof.

2. Description of the Related Art

In general, a bicycle is a means of transportation for a short distance, and widely used for enhancement of heath or as a hobby.

In recent years, an electric bicycle having a motor has been developed to be driven by a driving force of the motor so as to travel in long distance, or reduce physical exhaustion.

The motor installed on the bicycle to provide a driving force is used while being installed on a front wheel or a rear wheel (hereinafter, referred to as a wheel in common) of the bicycle, or on a frame constituting a body of the bicycle. In a case of having the motor installed on the frame, in order to transfer a driving force of the motor to the wheel, a power transmission member is additionally needed. Accordingly, the motor is installed on the wheel to directly transfer the driving force to the wheel.

Meanwhile, the wheel is constituted by a metal rim having a tire installed at an outer surface thereof, a hub to which a rotation shaft of the wheel is coupled, and a spoke connecting the hub to the rim.

In installing the motor on the wheel, an installation member is additionally used, thereby leading to an inconvenience in assembly process. In order to support the motor of weight, the wheel is constituted by components formed of metal, thereby increasing the cost of the bicycle.

### SUMMARY

Therefore, it is an aspect of the present disclosure to provide a motor housing integrated-type spoke for an electric bicycle, a manufacturing method thereof, a wheel assembly having the same, and a manufacturing method thereof, capable of enabling a motor to be easily installed to the bicycle and capable of improving the rigidity while reducing the weight and cost of the wheel.

It is another aspect of the present disclosure to provide a motor housing integrated-type spoke for an electric bicycle, a manufacturing method thereof, a wheel assembly having the same, and a manufacturing method thereof, capable of ensuring easy manufacturing and assembly process.

Additional aspects of the disclosure will be set forth in part in the description which follows and, in part, will be obvious from the description, or may be learned by practice of the disclosure.

In accordance with one aspect of the present disclosure, a motor housing integrated-type spoke coupled to a rim for an electric bicycle, the motor housing integrated-type spoke includes a motor housing, which is provided at a center of the motor housing integrated-type spoke to accommodate a motor, the motor housing integrally formed with the motor housing integrated-type spoke through an injection molding.

A reinforcing member may be provided at an end portion of the motor housing integrated-type spoke, and the reinforcing member may be integrally formed with the motor housing integrated-type spoke through an injection molding.

The motor housing integrated-type spoke may be formed of plastic, and the motor housing and the reinforcing member have rigidity larger than a rigidity of the motor housing integrated-type spoke.

The motor housing integrated-type spoke may be provided with a plurality of support members that radially extends from a center thereof, and the support member, the motor housing and the reinforcing member may be integrally formed with one another through an insert injection.

In accordance with another aspect of the present disclosure, a wheel assembly for an electric bicycle includes a rim and a spoke. The rim may be provided in a ring shape and have a rubber wheel installed at an outer circumferential surface thereof. The spoke may be integrated with a plurality of support members, which are formed of plastic and radially extending from a center of the spoke, and a motor housing, which is provided at the center of the spoke and formed of material having a rigidity larger than rigidity of the support member to accommodate a motor, through an injection molding.

A reinforcing member having rigidity larger than a rigidity of the support member may be provided at an end portion of each of the plurality of support members coupled to the rim, thereby improving a rigidity of the rubber wheel.

The reinforcing member may be integrally formed with the support member through an insert injection.

The reinforcing member facing the rim may be provided with a fastening groove having a screw thread, and the rim may be provided with a through hole at a position corresponding to the fastening groove, so that the rim is coupled to the spoke by screwing a fastening bolt to the fastening groove while passing through the through-hole.

The wheel assembly may further include a motor cover installed on the motor housing to close an open end portion of the motor housing through which a motor is accommodated.

The motor housing may be provided with a plurality of protrusions protruding outwardly while being spaced apart from one another along an outer circumference of the open end portion of the motor housing. The protrusion may be provided with a coupling groove having a screw thread, so that a coupling bolt that passes through the motor cover is screwed to the coupling groove.

In accordance with another aspect of the present disclosure, a method of manufacturing a motor housing integrated-type spoke includes steps of (a1) and (b1). In the step (a1), a motor housing and a reinforcing member, each of which having a predetermined rigidity are formed. In (b1), the motor housing and the reinforcing member are inserted in a mold, and the motor housing integrated-type spoke is formed while being integrated with the motor housing and the reinforcing member through an injecting molding. The motor housing and the reinforcing member each may have a rigidity larger than a rigidity of the motor housing integrated-type spoke.

In the step (b1), the motor housing integrated-type spoke may be provided with a plurality of support members radially extending from a center thereof. The motor housing integrated-type spoke may be molded by disposing the motor housing at the center of the motor housing integrated-type spoke and disposing the reinforcing member at an end portion of the support member.

In accordance with another aspect of the present disclosure, a method of manufacturing a wheel assembly of an electric bicycle includes steps (a2) and (b2). In the step (a2), a rim having a predetermined rigidity and provided in a shape of a ring is formed. In the step (b2), the motor housing integrated-type spoke, which is manufactured through claim 11 or claim 12, is installed on the rim.

As described above, a support member formed of plastic is integrally formed with a motor housing and a reinforcing member, which have rigidity larger than that of the support member, through an injection molding, so that the cost and weight are reduced while improving the rigidity.

In addition, since the motor housing is integrally formed into the spoke, an installation member to install the motor on the wheel is not additional needed, thereby ensuring easy installation of the motor.

In addition, since the spoke having the motor housing integrally formed with the support member is provided, the assembly process with respect to the rim is easily performed. Since insert injection is available for manufacturing the spoke, various designs are implemented and adopted.

Meanwhile, a reinforcing member is selectively adopted at an end portion of the support member coupled to the rim, so that the rigidity is further improved depending on the demand of a user.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an electric bicycle in accordance with one embodiment of the preset disclosure.

FIG. 2 is a plan view of FIG. 1

FIG. 3 is a side view of FIG. 1.

FIG. 4 is an exploded perspective view illustrating a wheel assembly of the electric bicycle in accordance with the one embodiment of the preset disclosure.

FIG. 5 is an assembled perspective view of FIG. 4.

### DETAILED DESCRIPTION

Reference will now be made in detail to the embodiments of the present disclosure, examples of which are illustrated in the accompanying drawings, wherein like reference numerals refer to like elements throughout.

The present disclosure is characterized in a wheel assembly for an electric bicycle, a manufacturing method thereof, a motor housing integrated-type spoke provided on a wheel and a manufacturing method thereof. Prior to the description of the characteristics of the present disclosure, an electric bicycle adopted with the present disclosure will be described in brief.

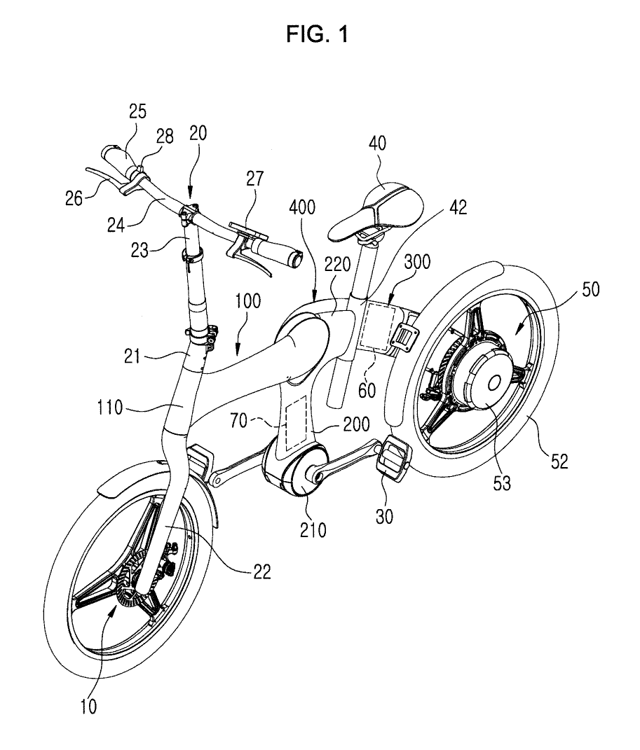

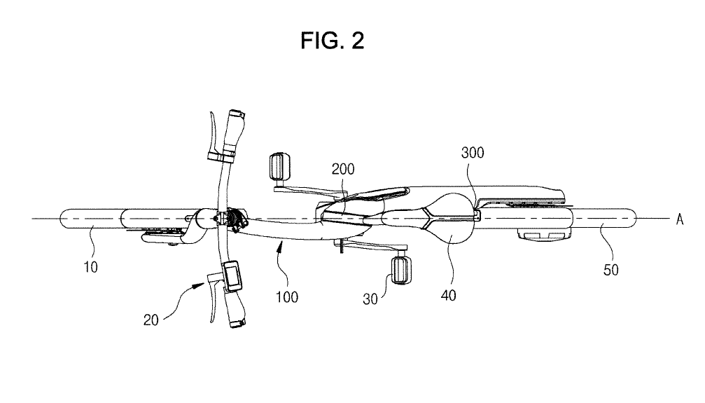

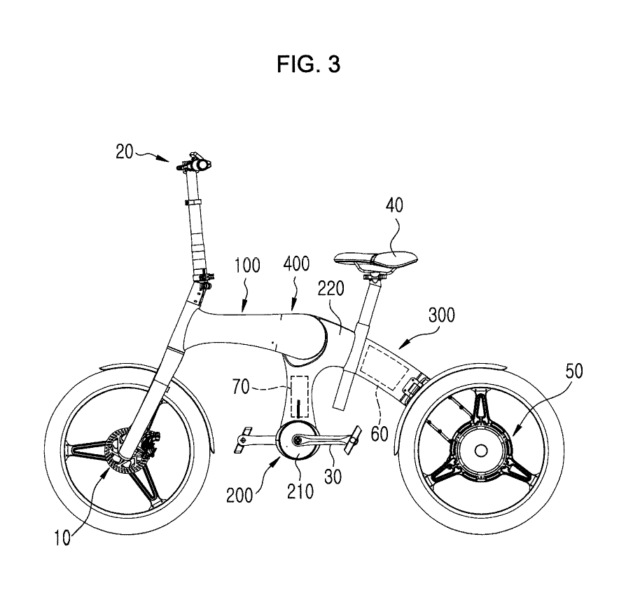

FIG. 1 is a perspective view illustrating an electric bicycle in accordance with one embodiment of the preset disclosure, FIG. 2 is a plan view of FIG. 1, and FIG. 3 is a side view of FIG. 1.

Referring to FIGS. 1 to 3, an electric bicycle in accordance with an embodiment of the present disclosure includes a front frame 100 provided with a front wheel 10 and a handle portion 20, a center frame 200 provided with a pedal 30 and a saddle 40, and a rear frame 300 provided with a rear wheel 50. The front frame 100, the center frame 200 and the rear frame 300 are coupled to one another so as to be rotated on a hinge coupling portion 400 of the center frame 200.

The front frame 100 is provided in the form of a bar having an interior space. A handle tube 110 is provided at one end of the front frame 100, and the center frame 200 is rotatably coupled to the other end of the front frame 100. The handle tube 110 is provided in hollowness such that a handle stem 21 is rotatably coupled to the handle tube 110. The handle stem 21 is provided with a front wheel fixing frame 22 at a lower side of the handle tube 110, and provided with a handle fixing frame 23 at an upper side of the handle tube 110. The front wheel fixing frame 22 is provided by partially bending the handle stem 21 from a center to a lateral side such the front wheel 10 is disposed in the same line (‘A’ of FIG. 2) with the rear wheel 50. The handle fixing frame 23 supports the center of a handle bar 24 that is provided in the form of a bar. Each end portion of the handle bar 24 is provided with a grip 25 and a brake lever 26 for braking the front wheel 10 and the rear wheel 50. A display apparatus 27 is detachably installed at one side of the handle bar 24 to display information of the electric bicycle, such as speed change or battery of the electric bicycle, and a lever 28 is installed at the other side of the handle bar 24 for speed change.

The center frame 200 has an interior space and is provided in the form of a bar. The pedal 30 is provided at one end of the center frame 200, and the front frame 100 and the rear frame 300 are rotatably coupled to the other end of the center frame 200. The one pair of pedals 30 is provided so as to be rotated on a pedal coupling portion 210 provided on the center frame 200. At an inside of the pedal coupling portion 210, a generator (not shown) is provided to convert a rotary power of the pedal 30 into an electric energy, and the electric energy charges a battery 60 electrically connected to the generator. At the interior space of the center frame 200, an engine control unit (ECU) 70 is provided for the electrical connection and control between the generator and other electronic components.

In addition, the center frame 200 may include a saddle frame 220 on which the saddle 40 is installed. The saddle frame 220 is provided at a rear side thereof with a saddle tube 42 on which the saddle 40 is installed. A saddle rod (not shown) is coupled to the saddle tube 42 to adjust the height of the saddle 40.

The rear frame 300 has an interior space and provided in the form of a bar. The rear wheel 50 is rotatably installed at one end of the rear frame 300, and the center frame 200 is rotatably installed at the other end of the rear frame 300.

At the interior space of the rear frame 300, the battery 60 and a battery management system (not shown) are provided that are electrically connected to the ECU 70 provided on the center frame 200. The motor installed on the rear frame 300 is disposed on the rear wheel 50. The motor (not shown) is accommodated in a motor housing 53 that is installed on the rear wheel 50, and configured to rotate the rear wheel 50 by receiving a driving force from the battery 60 according to the control of the ECU 70.

In this case, the motor is implemented using an outer rotor scheme. The outer rotor scheme is a type of a motor driving scheme, which has a fixed center shaft and a rotor disposed at a periphery of the center shaft, and the rotor is connected to a rotating body, such as a wheel, to rotate together with the rotating body.

As described above, the front frame 100, the center frame 200 and the rear frame 300 are provided in a foldable structure that enables the front frame 100 and the rear frame 300 are rotated on the center frame 200 by the hinge coupling portion 400.

Hereinafter, a motor housing integrated-type spoke and a wheel assembly having the same will be described in detail. The wheel assembly may be used for as the front wheel 10 or the rear wheel 50 of the electric bicycle described above. In the drawings, the motor and the motor housing 53 are illustrated as provided on the rear wheel 50. Accordingly, the following description will be made in relation that the wheel assembly represents the rear wheel of the electric bicycle.

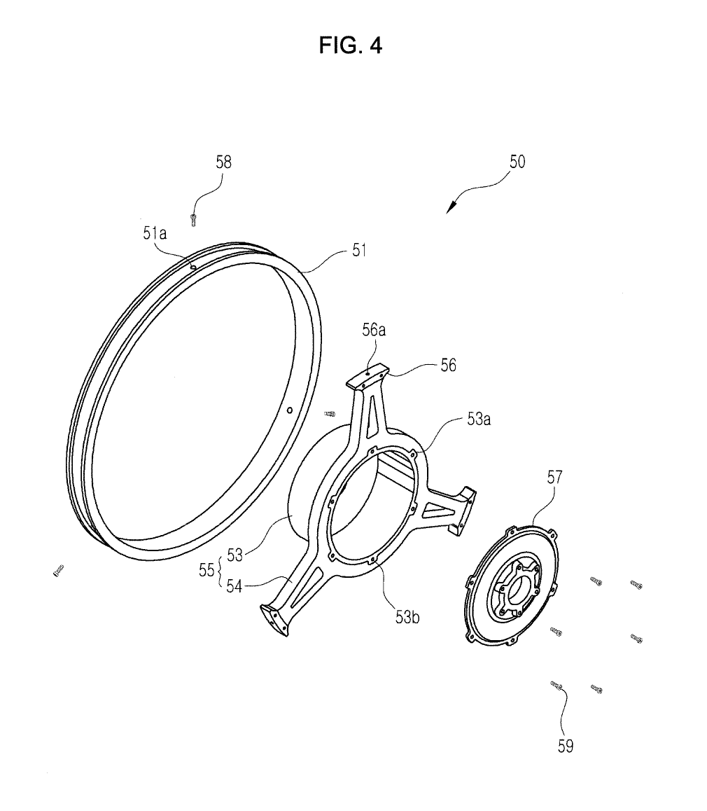

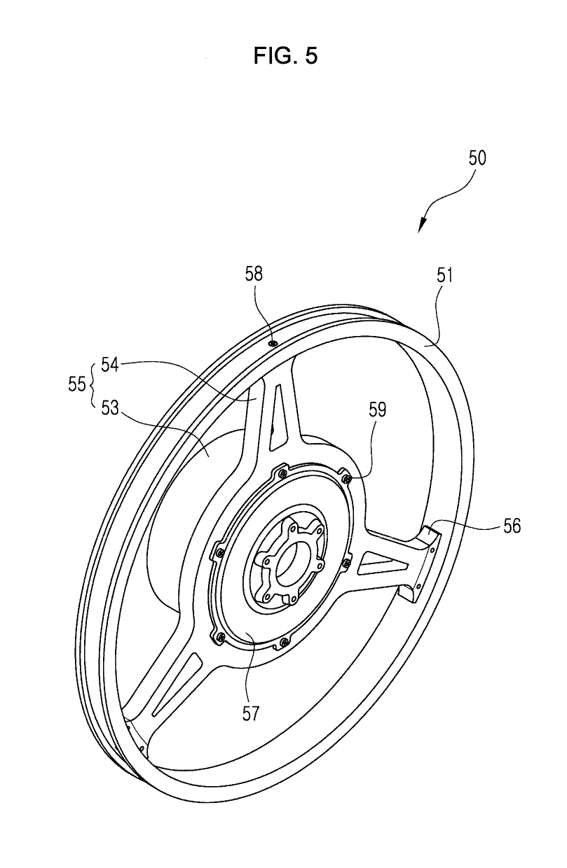

FIG. 4 is an exploded perspective view illustrating a wheel assembly of the electric bicycle in accordance with one embodiment of the preset disclosure, and FIG. 5 is an assembled perspective view of FIG. 4.

Referring to FIGS. 4 and 5, the wheel assembly is provided with a rim 51 having a ring shape, and a spoke 55 coupled to the rim 51.

The rim 51 is formed of metal, for example, an aluminum alloy, to improve the rigidity of the rim 51. A tire (‘52’ in FIG. 1) is installed at an outer circumferential surface of the rim 51.

The motor housing integrated-type spoke 55 is provided with a plurality of support members 54 radially extending from a center thereof, and the motor housing 53 to accommodate the motor (not shown).

In more detail, the motor housing integrated-type spoke 55 is formed as an integral body by performing injection molding on the plurality of support members 54, which is formed of plastic, with the motor housing 53, which has rigidity larger than that of the support member 54 and provided at the center of the plurality of support members 54. In this case, the motor housing 53 may be formed of metal having rigidity larger than that of the support member 43, for example, an aluminum alloy. Other material having rigidity larger than that of the support member 54 may be available for the material of the motor housing 53.

In addition, the motor housing 53 has one side that is opened to accommodate the motor. The support member 54 is formed to surround the outer circumference of the open side of the motor housing 53. The motor housing 53 is provided with protrusions 53a, which are spaced apart from one another along the outer circumferential surface of the motor housing 53 and to which a motor cover 57, which is to be described later, is coupled.

The motor housing integrated-type spoke 55 has an end portion of each support member 54 installed at an inner circumferential surface of the rim 51. In order to improve the rigidity of the spoke 55, a reinforcing member 56 may be provided at the end portion of each support member 54. The reinforcing member 56 may be formed of material having rigidity larger than that of the support member 54, for example, an aluminum alloy, tungsten, and stainless steel.

The reinforcing member 56 may be integrally formed with the support member 54 through injection molding, similar to the motor housing 53. That is, the motor housing integrated-type spoke 55 is formed by integrally forming the plurality of support members 54, the motor housing 53 and the reinforcing member 56 through injection molding. The injection molding may be implemented using an insert molding process.

A method of manufacturing the motor housing integrated-type spoke 55 is as follows. First, the motor housing 53 and the reinforcing member 56 each having a predetermined rigidity are formed. Thereafter, the motor housing 53 and the reinforcing member 56 are inserted into a mold, and the motor housing integrated-type spoke 55 having the plurality of support member 54 and formed of plastic is molded while being integrated with the motor housing 53 and the reinforcing member 56 through an injection molding. In this case, the motor housing integrated-type spoke 55 is molded such that the motor housing 53 is disposed on the center of the motor housing integrated-type spoke 55 so as to have one side open while the reinforcing member 56 is disposed at each end portion of the support member 4, as an integral body as shown in FIG. 4.

The rim 51 having a ring shape is manufactured before the manufacturing of the motor integrated-type spoke 55 as such, and the motor housing integrated-type spoke 55 is manufactured as such and coupled to the rim 51, thereby completing the manufacturing of the wheel assembly.

The motor housing integrated spoke 55 is coupled to the rim 51 in a structure to couple the motor housing integrated spoke 55 to the inner circumferential surface of the rim 51 through a fastening bolt 58. That is, the reinforcing member 56 provided at each end portion of the support member 54 coupled to the rim 51 is provided with a fastening groove 56a having a screw thread formed at an inner circumferential surface thereof, and the rim 51 is provided with a through-hole 51a at a position corresponding to the fastening groove 56a. Accordingly, by screwing a fastening bolt 58 to the fastening groove 56a through the through-hole 51a, the spoke 55 is coupled to the rim 51.

Meanwhile, the motor housing integrated-type spoke 55 is provided with the motor cover 57 that is installed on the motor housing 53 to cover the open side of the motor housing 53. As describe above, the motor housing 53 is provided with the protrusion 53a to be coupled to the motor cover 57. The protrusion 53a is provided with a coupling groove 53b having a screw thread, and as a coupling bolt 59 is screwed to the coupling groove 53b while passing through the motor cover 57, the motor housing 53 is coupled to the motor cover 57. The protrusion 53a serves to secure the coupling between the motor housing 53 and the support member 54 while facilitating rotating the motor housing 53 and the wheel 50.

As described above, the wheel assembly for the electric bicycle is provided with the motor housing integrated-type spoke 55 and the rim 51 while having the support member 54 and the motor housing 53 of different material integrally formed with each other through insert injection, thereby reducing the cost and the weight. In addition, no installation component is needed to install the motor, thereby ensuring an easy assembly process.

Although the description has been made in relation that the wheel assembly having the motor housing integrated-type spoke 55 is provided to be used as the rear wheel 50, the present disclosure is not limited thereto. In a case where a motor is installed at the front wheel 10, the front wheel 10 may have the same structure of the rear wheel 50 described above.

Meanwhile, as for a wheel assembly of the front wheel 10, on which a motor is not installed, the wheel assembly is provided with a rim 11 and a spoke 15. The spoke 15 may be installed on the rim 11 while including a hub (not shown) coupled to a rotating shaft (not shown) of the wheel 10, and a plurality of support members 14 integrally formed with the hub. That is, similar to the motor housing integrated-type spoke 55 described above, the spoke 15 may be formed as an integral body composed of the plurality of support members 14, the hub provided at the center of the support members 14, and a reinforcing member 16 provided at each end portion of the support members 14 through injection molding.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. A motor housing integrated-type spoke coupled to a rim for an electric bicycle, the motor housing integrated-type spoke comprising a motor housing, which is provided at a center of the motor housing integrated-type spoke to accommodate a motor, the motor housing integrally formed with the motor housing integrated-type spoke through an injection molding.

2. The motor housing integrated-type spoke of claim 1, wherein a reinforcing member is provided at an end portion of the motor housing integrated-type spoke, and the reinforcing member is integrally formed with the motor housing integrated-type spoke through an injection molding.

3. The motor housing integrated-type spoke of claim 2, wherein the motor housing integrated-type spoke is formed of plastic, and the motor housing and the reinforcing member have rigidity larger than a rigidity of the motor housing integrated-type spoke.

4. The motor housing integrated-type spoke of claim 3, wherein the motor housing integrated-type spoke is provided with a plurality of support members that radially extends from a center thereof, and the support member, the motor housing and the reinforcing member are integrally formed with one another through an insert injection.

5. A wheel assembly for an electric bicycle comprising:
a rim provided in a ring shape and having a rubber wheel installed at an outer circumferential surface thereof; and
a spoke integrated with a plurality of support members, which are formed of plastic and radially extending from a center of the spoke, and a motor housing, which is provided at the center of the spoke and formed of material having a rigidity larger than rigidity of the support member to accommodate a motor, through an injection molding

6. The wheel assembly of claim 5, wherein a reinforcing member having rigidity larger than a rigidity of the support member is provided at an end portion of each of the plurality of support members coupled to the rim, thereby improving a rigidity of the rubber wheel.

7. The wheel assembly of claim 6, wherein the reinforcing member is integrally formed with the support member through an insert injection.

8. The wheel assembly of claim 6, wherein the reinforcing member facing the rim is provided with a fastening groove having a screw thread, and the rim is provided with a through hole at a position corresponding to the fastening groove, so that the rim is coupled to the spoke by screwing a fastening bolt to the fastening groove while passing through the through-hole.

9. The wheel assembly of claim 5, further comprising a motor cover installed on the motor housing to close an open end portion of the motor housing through which a motor is accommodated.

10. The wheel assembly of claim 9, wherein the motor housing is provided with a plurality of protrusions protruding outwardly while being spaced apart from one another along an outer circumference of the open end portion of the motor housing, and
the protrusion is provided with a coupling groove having a screw thread, so that a coupling bolt that passes through the motor cover is screwed to the coupling groove.

11. A method of manufacturing a motor housing integrated-type spoke, the method comprising:
(a1) forming a motor housing and a reinforcing member, each of which having a predetermined rigidity; and
(b1) inserting the motor housing and the reinforcing member in a mold, and molding the motor housing integrated-type spoke integrated with the motor housing and the reinforcing member through an injecting molding,
wherein the motor housing and the reinforcing member each have a rigidity larger than a rigidity of the motor housing integrated-type spoke.

12. The method of claim 11, wherein in the step (b1),
the motor housing integrated-type spoke is provided with a plurality of support members radially extending from a center thereof, and
wherein the motor housing integrated-type spoke is molded by disposing the motor housing at the center of the motor housing integrated-type spoke and disposing the reinforcing member at an end portion of the support member.

13. A method of manufacturing a wheel assembly of an electric bicycle, the method comprising:
(a2) forming a rim having a predetermined rigidity and provided in a shape of a ring; and
(b2) installing the motor housing integrated-type spoke, which is manufactured through claim 12, on the rim.
